(19) United States
(12) Patent Application Publication
(10) Pub. No.: US 2025/0095225 A1
(43) Pub. Date: Mar. 20, 2025

(54) AUGMENTED REALITY AND TABLET INTERFACE FOR MODEL SELECTION

(71) Applicant: TELEFONAKTIEBOLAGET LM ERICSSON (PUBL), Stockholm (SE)

(72) Inventors: Sathaporn Hu, Halifax (CA); Derek Reilly, Halifax (CA); Saman Bashbaghi, Candiac (CA)

(21) Appl. No.: 18/728,368

(22) PCT Filed: Mar. 25, 2022
(86) PCT No.: PCT/IB2022/052779

§ 371 Date: Jul. 11, 2024

(51) Int. Cl. G06T 11/00

(52) U.S. Cl. CPC G06T 11/00; G06T 2200/24

(57) ABSTRACT

The disclosure relates to a method, surface display, augmented reality (AR) wearable display and system for displaying and fitting a dataset into a model. The method comprises displaying the dataset through a combination of a surface display and an AR wearable display, the dataset comprising a plurality of variables. The method comprises receiving a selection of variables, from the plurality of variables. The method comprises, using the selection of variables, fitting the dataset into a first model. The method comprises displaying a first goodness-of-fit corresponding to the first model and a second goodness-of-fit corresponding to a second model, through the combination of the surface display and the AR wearable display.

### TECHNICAL FIELD

The present disclosure relates to displaying data using a combination of a surface display and an augmented reality (AR) wearable display.

### BACKGROUND

Regression is a machine learning technique that is used to analyze the importance of independent variables in different models. The regression technique generates a function that allows making a prediction based on new data. Alternatively, the regression technique can be used to find the importance of different variables, akin to analysis of variance (ANOVA). ANOVA enables finding out whether differences between groups of data are statistically significant.

There exist visualization techniques for map-based visualization that represent predictions made by regression. For example, Kumar et al. (Kumar, P., Sharma, L. K., Pandey, P. C., Sinha, S., Nathawat, M. S. (2013), Geospatial Strategy for Tropical Forest-Wildlife Reserve Biomass Estimation, IEEE Journal of Selected Topics in Applied Earth Observations and Remote Sensing, 6 (2), p. 917-923.) describe a technique that creates an overlay on a map. The overlay represents predicted biomass in a specific area. The literature and techniques on visualizing predicted values are quite robust.

Some work in cross reality (XR) statistical visualization is also available. Two works (Sicat, R., Li, J., Choi, J., Cordeil, M., Jeon, W.-K., Bach., B., Pfister, (2019). DXR: A Toolkit for Building Immersive Data Visualizations. IEEE Transactions on Visualization and Computer Graphics, 25 (1), p. 715-725.) and IATK (Cordeil, M., Cunningham, A., Bach, B., Hurter, C., Thomas, B. H., Mariott, K., Dwyer, T. (2019), IATK: An Immersive Analytics Toolkit, 2019 IEEE Conference on Virtual Reality and 3D User Interfaces (VR), p. 200-209.) allow one to create visualization like the three dimensional (3D) scatterplot in XR.Buschel et al. (Wolfgang Büschel, Anke Lehmann, and Raimund Dachselt (2021), MIRIA: A Mixed Reality Toolkit for the In-Situ Visualization and Analysis of Spatio-Temporal Interaction Data, In CHI Conference on Human Factors in Computing Systems (CHI '21), May 8-13, 2021, Yokohama, Japan. ACM, New York, NY, USA 15 pages.) who introduced MIRIA which allows a user to be presented with statistical information in augmented reality (AR) in conjunction with tablets. STREAM by Hubenschmid et al. (Hubenschmid, S., Zagermann, J., Butscher, S., Reiterer, H. (2021). STREAM: Exploring the Combination of Spatially-Aware Tablets with Augmented Reality Head-Mounted Displays for Immersive Analytics. Proceedings of the 2021 CHI Conference on Human Factors in Computing Systems, (469), p. 1-14.) enables visualization of spatial information.

### SUMMARY

There is provided a method for displaying and fitting a dataset into a model. The method comprises displaying the dataset through a combination of a surface display and an augmented reality (AR) wearable display, the dataset comprising a plurality of variables. The method comprises receiving a selection of variables, from the plurality of variables. The method comprises, using the selection of variables, fitting the dataset into a first model. The method comprises displaying a first goodness-of-fit corresponding to the first model and a second goodness-of-fit corresponding to a second model, through the combination of the surface display and the AR wearable display.

There is provided a system, comprising a surface display and an augmented reality (AR) wearable display. The surface and AR wearable displays each comprise processing circuits and a memory, the memory containing instructions executable by the processing circuits. The system is operative to display the dataset through the surface display and the augmented reality (AR) wearable display, the dataset comprising a plurality of variables. The system is operative to receive a selection of variables, from the plurality of variables. The system is operative to use the selection of variables for fitting the dataset into a first model. The system is operative to display a first goodness-of-fit corresponding to the first model and a second goodness-of-fit corresponding to a second model, through the combination of the surface display and the AR wearable display.

There is provided a non-transitory computer readable media having stored thereon instructions for displaying and fitting a dataset into a model. The instructions comprise displaying the dataset through a combination of a surface display and an augmented reality (AR) wearable display, the dataset comprising a plurality of variables. The instructions comprise receiving a selection of variables, from the plurality of variables. The instructions comprise, using the selection of variables, fitting the dataset into a first model. The instructions comprise displaying a first goodness-of-fit corresponding to the first model and a second goodness-of-fit corresponding to a second model, through the combination of the surface display and the augmented reality (AR) wearable display.

The method, devices and system provided herein present improvements to the way displaying and fitting a dataset into a model operate.

### BRIEF DESCRIPTION OF THE DRAWINGS

FIG. 1 is a block diagram representing the hardware and software platforms for the solution.

FIG. 2 is a flowchart illustrating steps of data selection.

FIG. 3 is an example user interface data selection screen, showing data sources available for selection.

FIG. 4 is a schematic illustration of example glyphs.

FIG. 5 is a flowchart illustrating steps of the pre-stage.

FIG. 6 is an example screenshot of a pre-stage on the tablet, where the glyphs (not illustrated) would be visible in AR over the tablet screen.

FIG. 7 is an example user interface variable picker dialog.

FIG. 8 is an example user interface equation modeler dialog.

FIG. 9 is a flowchart of the post-stage where the user compares the model generated against another existing model.

FIG. 10 is an example user interface comparison dialog.

FIGS. 11a, 11b and 11c are display captures, taken with a prototype system,

illustrating example glyphs; the pre-stage is illustrated in FIGS. 11a and 11b for and the post-stage is illustrated in FIG. 11c.

FIG. 12 is a flowchart of a method for displaying and fitting a dataset into a model.

FIG. 13 is a schematic illustration of a device in which steps and/or method described herein can be executed.

FIG. 14 is a schematic illustration of a virtualization environment in which the different methods and devices described herein can be deployed.

FIG. 15 is a schematic illustration of a cloud environment in which the different methods and devices described herein can be deployed.

### DETAILED DESCRIPTION

Various features will now be described with reference to the drawings to fully convey the scope of the disclosure to those skilled in the art.

Sequences of actions or functions may be used within this disclosure. It should be recognized that some functions or actions, in some contexts, could be performed by specialized circuits, by program instructions being executed by one or more processors, or by a combination of both.

Further, computer readable carrier or carrier wave may contain an appropriate set of computer instructions that would cause a processor to carry out the techniques described herein.

The functions/actions described herein may occur out of the order noted in the sequence of actions or simultaneously. Furthermore, in some illustrations, some blocks, functions or actions may be optional and may or may not be executed; these are generally illustrated with dashed lines.

At least some aspects of the techniques described herein could be implemented using artificial intelligence, which comprises a variety of techniques as would be apparent to a person skilled in the art, including machine learning techniques such as Neural Network (NN) or Artificial Neural Network (ANN).

The system described herein allows a user to holistically diagnose a model, that is going to be fitted onto some data, from the very first stage until the very end. The system involves visualization using augmented reality with a tablet, or any other type of surface display. In the description below, the term tablet is used, but it should be understood as meaning a surface display. The system allows visualization using glyph layers to present to the user variance structures that can be analyzed to select an appropriate model. In the context of this application, a glyph is defined as a visual marker on a map. A glyph can have different appearances, to convey different information. For example, glyphs can have different colors, to represent different categories, or can vary in size, to represent different values of a variable. In some contexts, a glyph could represent more than one variable. For instance, to represent velocity at a certain point, a glyph would need to not only present the speed but also the direction. In such case, an arrow could be used as a glyph with the direction of the arrow representing the direction and the length or size of the arrow representing the speed. An alternative could be to create a composite glyph with a combination of multiple glyphs.

A glyph layer, in the context of this specification, is a layer containing markers pertaining to a category or being associated with a particular variable. If glyphs are represented using colors, different blending techniques (additive, subtractive, multiplied, etc.) could be applied, as would be apparent to a person skilled in the art.

Unlike the automated methods of model selection such as principal component analysis (PCA), the system proposed herein is designed to enable methodical exploration of data-based multicollinearity and careful selection of variables that have been projected onto a map before fitting the model. It is also meant to enable scrutinizing likelihood ratio tests and seeing how test results might vary based on regions of the map.

In the context of this specification, likelihood, likelihood ratio or likelihood ratio test, as well as goodness-of-fit may all be used interchangeably and indicate how well a dataset fits into a model. A likelihood function represents a probability of a set of estimated parameters being the true parameters, given observed data. First, f(xᵢ|θ) is computed, where f is the probability of xᵢ being the outcome if θ is used in the model, θ being a set of parameters. For instance, in linear regression, θ can be a set of coefficients. Certain types of regressions, such as linear regression, already have their own version of f. A likelihood L is posited to be L(θ|xᵢ)=f(xᵢ|θ). For all data, and not just xᵢ, the likelihood is the joint likelihoods for all xᵢ: L(θ|x)=Πᵢ₌₁ⁿf(xi|θ).

A likelihood function can be used to find the best estimated parameters for the observed data. Since this involves selecting various candidate estimated parameters that will yield a maximum probability, it is called Maximum Likelihood Estimate (MLE). Some examples of likelihood functions are presented here:
Multiple Linear Regression:

$$f ( {x}_{i} \vert θ ) = \frac{1}{\sqrt{2 π σ}} {e}^{- \frac{{∈}_{i}^{2}}{2 {σ}^{2}}}$$

where ∈ⁱ is an error and σ is the standard deviation of all errors.
Logistics Regression: f(xi|θ)=(ŷᵢ)^{y}^{ᵢ}(1−ŷᵢ)^{1-y}^{ᵢ}, where yᵢ is the observed datum and ŷᵢ is the datum predicted by the model.

30 The system provided herein is not fully automated, it requires human intervention and input. Applications that can benefit from the system described herein include applications designed toward social sciences or applications having a small number of variables that are high-stake in nature.

The system comprises a computer tablet and a holographic device and aims, using map-based visualization, to:
Allow the user to understand some aspect of parsimony before fitting the data.
Assist the user with model selection after fitting is performed. In this aspect, the system is superior to the current techniques because it allows selecting variables and equation coefficients, which are steps that are usually unavailable to the user. Furthermore, the system is designed to follow how the user would normally perform data analysis after the data collection is performed.
Allow the user to inspect likelihood ratio test through map-based visualization. Prior to this, there was no solution for visualizing likelihood ratio tests in such fine detail. This permits users to see regional trends, which can facilitate regional model selection.

Some problems with prior techniques are discussed below.

Creating a good model, for fitting into a dataset, involves more than making good predictions. A regression algorithm can create a model based on the dataset and given parameters regardless of whether the output model makes sense or not. But to get a good model, a person needs to select the good model among other models. In order to do so, different measures can be used. If the model is a multiple linear regression model, a R-squared or adjusted R-squared can be used. For any other model, a likelihood function can be used.

With the advance in computer technologies, it is possible to automate the process of model selection. However, this automation creates atheoretical models and therefore, is quite prone to spurious or erroneous correlation. Unlike map-based visualization for prediction, visualization of goodness-of-fit, or measure of a model's quality, is lacking today.

Current map-based visualization techniques focus primarily on prediction. These techniques do not aim at visualization of other important elements that are involved in model selection, such as goodness-of-fit. Goodness-of-fit is a statistical hypothesis test used to see how closely observed data mirrors expected data. While one can automate the model selection process, the automation can be opaque. Automation processes in existence today do not care if the model is spurious or not. Having the user being able to inspect the process before and after fitting could therefore be highly beneficial.

### Data Analysis Prior to Fitting

Parsimony is the idea that a model should have the least number of variables as possible. Some model selection techniques have mechanisms to penalize for having too many variables, may be able to detect some extraneous variables before fitting.

Data-based multicollinearity is a type of multicollinearity that becomes apparent during data collection. Multicollinearity is a statistical concept where several independent variables in a model are correlated. Data-based multicollinearity can occur when some variables are too similar to each other. For example, in certain cases, age and educational level may be too familiar to each other. Eliminating data- based multicollinearity may be possible by trying to fit the independent variables and observe if they can linearly predict each other or not.

While some machine learning methods (e.g., Principle Component Analysis) can eliminate multicollinearity, they do not indicate where and why the multicollinearity exists. Such methods are useful when there are many low-stake variables such as the color value of a pixel in a handwriting sample. In such cases, trimming out variables mindlessly does not cause much problem. However, in some cases, like in social science, a variable can have a much higher stake. For example, a variable representing education level represents years of studies and challenges and is likely a high-stake variable.

### Model Selection

As mentioned before, automated model selection is not always good, and removal of an independent variable should be justified by a valid theory. There are multiple tools that can assist with model selection. The likelihood function is one of the many ways to analyze goodness-of-fit for a model. It represents the probability of observing data having a certain set of parameters (such as independent variables). A higher probability suggests a better fit than a lower probability. With automated selection, a software tool would try to fit models based on all subsets of the parameters and pick the models with the maximum probability.

Although there are techniques to visualize predicted values of a model overlaid on a map, none provide overlapping goodness-of-fit information onto the map. Existing techniques are limited to holistic analysis i.e., one global model applies to all of the map. However, it is possible that the selected parameters are stronger in one area of the map than in another. Different patterns of likelihood shown on the map, might trigger a need to perform more studies to find out the causes of the differences.

### Augmented Reality

Although not a new technology, headworn AR has been inaccessible to many for myriad reasons e.g., lack of commercialization, and development difficulties. Recently, with advances in software platforms like Unity™ and hardware platforms such as Microsoft® HoloLens™, there is a lower barrier for using headworn AR. This presents an exciting opportunity to apply AR and to expand the field of immersive analysis.

The system described herein includes a tablet and holographic device (AR device). The user performs input actions with the former, and the latter displays glyphs on top of the tablet. Test of the system have been conducted using a Microsoft® Surface Book™ 3, and Microsoft® HoloLens™ v2. The system includes a graphical and interactive interface which guides the user from the beginning to the end of a process which starts with selecting a model and ends after the fitting of the model. The user interacts with the tablet using touch gestures to perform 1-data selection: the user selects a data source that they would like to interact with. 2-Pre-stage: the user visualizes the variables that they want to compare. The user can also select the variables to add into a model. 3-Post-stage: the user compares the model generated against another existing model.

In the beginning, the system receives a selection, from a user, of a normalized data source for which a model should be created. After the selection, the variables are extracted based on the header of the data file.

The second step is a “pre-fit” stage. In this stage, the value of the data is presented to the user as glyph layers, where each layer is associated with a variable. The values (color, shade of grey, size, etc.) of the glyphs are represented by the relative strength (value or normalized value) of the data. The glyph layers can be stacked together to highlight potential for data-based multicollinearity and interaction between the variables. It should be noted that the glyphs can extend beyond the boundary of the tablet.

In the context of this specification, equation, model and mathematical model may be used interchangeably, although it should be understood that some models cannot be represented with an equation. An equation modeler is also made available to the user, to preview the fitting of the model and to help determine if the model is ready or not. The equation modeler also allows to add or remove terms that are no longer wanted in the model. After the needed adjustments are provided to the system, the equation modeler is ready to start fitting an equation in to the data.

In the “post-fit” process, the likelihood of each model is presented to the user as glyph layers. Each glyph represents an individual datum's likelihood. If the user stacks two layers, they are essentially performing visualized likelihood ratio test.

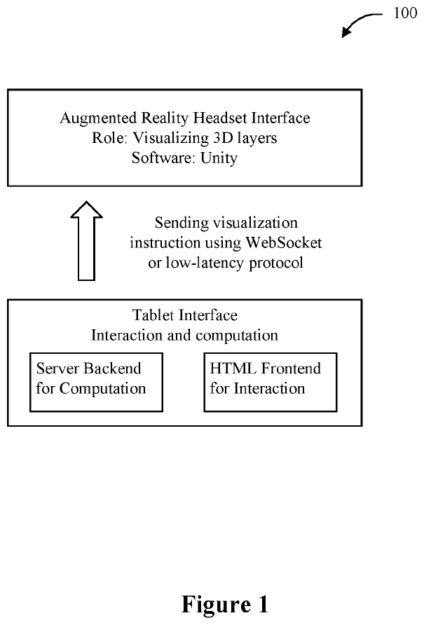

FIG. 1 is a block diagram representing the hardware and software platforms for the solution. Most of the tasks are performed by a tablet (example Microsoft® Surface™) that can execute statistical tasks. The tablet can also accept user input. The tablet preferably has a touch-friendly HTML interface that sends the user input to the backend for processing. The backend in this context can be the tablet itself, if it has sufficient processing power, or it could be another computer, a physical server or a virtual server in the cloud, for example. The tablet can also send information to the AR layer so that the AR headset can display information appropriately for visualization by the user. The main task of the AR layer is to provide visualization for the glyph layers. However, it might also be used it to display other supplementary data.

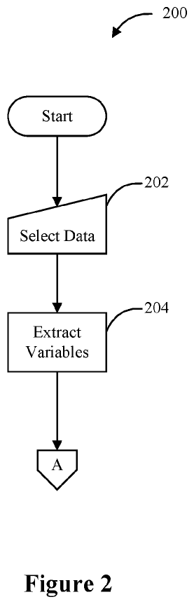

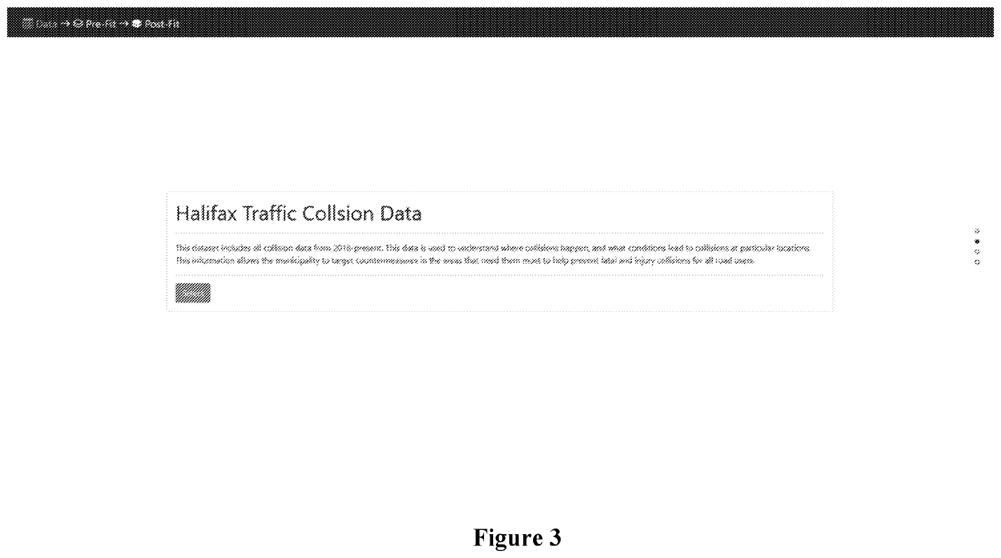

Turning to FIG. 2, a dataset selection interface is presented to the user. Data can be selected, step 202, from the interface. FIG. 3 illustrates a corresponding HyperText Markup Language (HTML) user interface prototype. After selection of the data source, the variables to be used can be extracted, step 204. The system parses the data and generates glyphs for the pre-fit stage based on variables and values for displaying in the AR headset. The data may need to be manipulated or converted by the system to allow correct display. Variables may need to be converted to a numerical representation and may need to have coordinates such as latitude and longitude, or another spatialization, for displaying purpose. Once the variables are extracted, and possibly converted, the variables are ready to be selected.

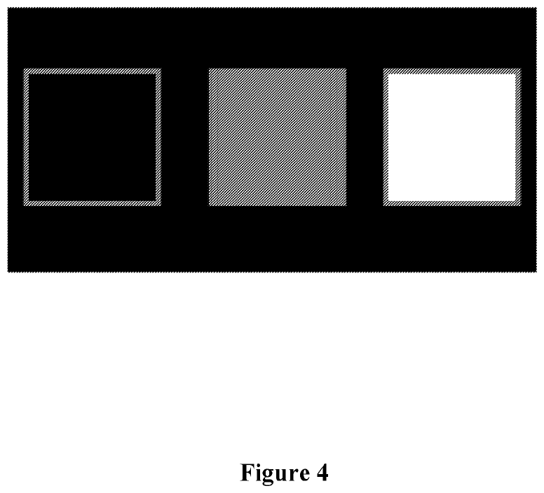

The next stage, the pre-fit stage, is illustrated in FIGS. 4 to 8 and 11a and 11b. At this stage, selected variables can be visualized as glyphs, which are superimposed over the tablet screen. The glyphs themselves can appear on top of the tablet or around the tablet display. There may be multiple layers of glyphs. For example, if the user selects three variables, there will be three layers floating on top of each other. Each glyph's value can indicate a value relative to the associated variable's minimum and maximum values. Fully transparent glyphs can represent minimum values while solid white glyphs can represent maximum values. Various shades of grey can represent values between the minimum and maximum. Alternatively, colors could be used to represent values. In the below description, color is used to characterize the value of a glyph. A person skilled in the art will understand that glyphs values may be represented otherwise than by color and that the use of the word color should not be limiting. Glyphs may also have borders to aid visibility. The color of the border can be set to the color of the maximum or minimum value, to aid comparison. The user can then compare the layers and try to see if there is a correlation or not between the variables. After observing the glyphs, the user may make find the following types of correlations:
Positive Correlation: One layer's color (or shade) value increases, and another layer's color value also increases.
Negative Correlation: One layer's color value increase and another layer's color value decreases.
No Correlation: No trend can be found.

If two layers seem to be correlated, the user may need to reconsider their inclusion into the model. Particularly, if the correlation is linear, the user may introduce data-based multicollinearity into the model if they proceed to add the correlated variables into the models.

Each pre-fit glyph represents a value at a specific location relative to the variable itself. The system assigns the color value using the following

$$c = \frac{{x}_{i} - min x}{\vert max x - min x \vert} ,$$

where xᵢ is a value for a variable x, and c is the color value. The value for c is between zero and one inclusively. Since the prototype system that was implemented using gray scale, it simply assigns the new color value as a 4D vector with the value of (c, c, c, c). Unity™ color component scales are between zero and one; therefore, there is no need to rescale c to 0 to 255 like in some other game or graphic engines.

In the prototype system that was implemented for test purposes, in the pre-fit stage, each glyph has a special shader that performs 2× multiplicative blends when two more glyphs are intersecting each other (some of these intersections are shown in FIGS. 1a, b and c). 2× multiplicative blend is used instead of a 1× blend, because with 1× blending, one of the glyphs would not be visible except in the area where blending occurs. Since HoloLens™ uses an additive screen, the shader also adds another rendering pass before the blending operation. In this pass, the glyphs leave white masks. Without the masks, some glyphs might turn invisible, because they are multiplied directly against the transparent background.

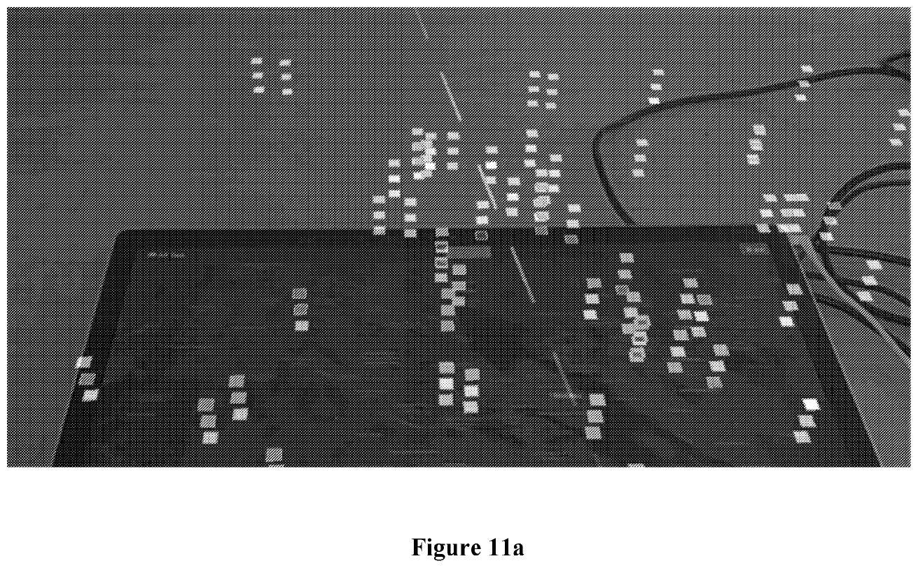

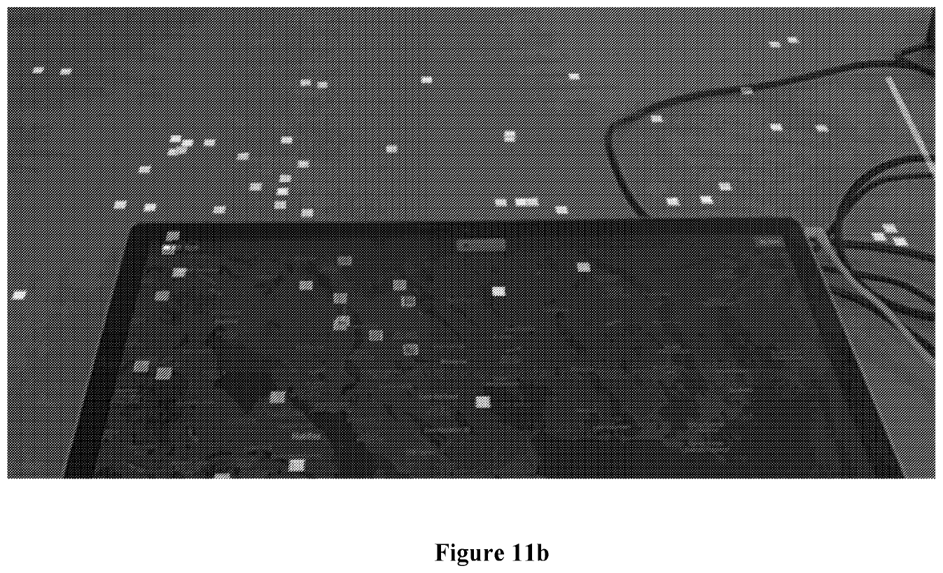

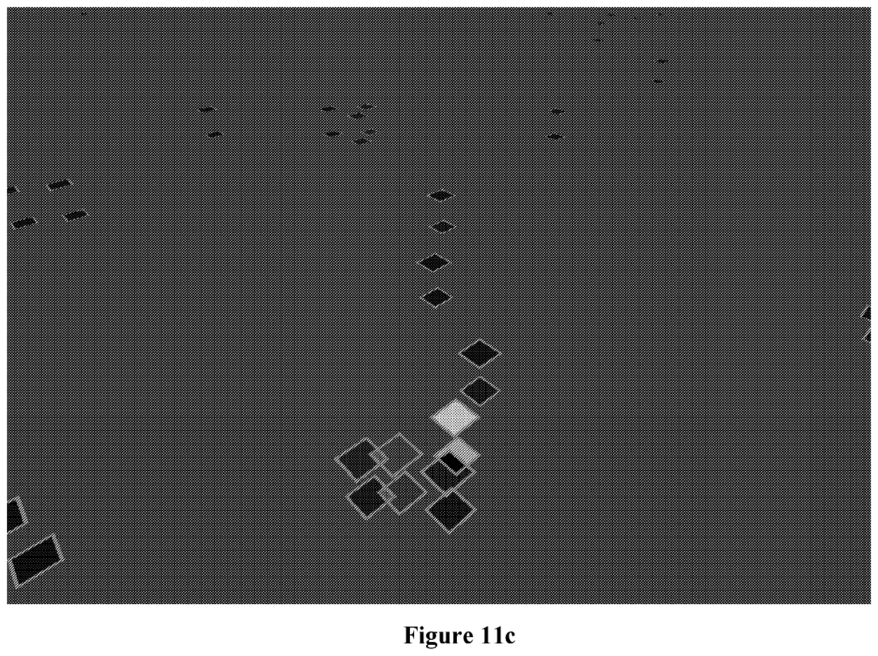

The implemented system has two display modes. In the first mode (FIG. 11a) the layers are separated. The second mode (FIG. 11b) uses multiplicative blending, where each blend represents the value C*=Πᵢ₌₁^{b}Cᵢ, where C* is a new color, and Cᵢ is the previous color before the blending process. Π represents a component-wise multiplication. Essentially, each glyph represents the relative multiplication strength. The blended glyphs indicated the strength of interaction that can be expected. The value of the glyph is defined as

$${x}_{i}^{*} = {\prod }_{l - 1}^{L} \frac{{x}_{l , i} - min {x}_{l}}{\vert max {x}_{l} - min {x}_{l} \vert} ,$$

where x*ᵢ represents a relative multiplication value, represents the layer index, L represents the number of variables associated with the layers, xₗ represents variable l.

Referring to FIG. 4, glyphs, illustrated as squares in the figure, play an important role in the system. The left glyph represents the minimum and the right glyph represents the maximum. Glyphs allow the user to understand the data and the goodness-of-fit of specific locations and how the data and goodness-of-fit may differ from each other. In the pre-fit stage of the workflow, each glyph describes the value of a datum of a variable relative to the other values of that variable. In the post-fit stage, as it will be explained in more details further below, each glyph describes the likelihood of a model of generating a datum.

The system can show the glyphs in different layers. The system can also composite the glyphs to convey different information using shaders with different blend modes. In the pre-fit stage, the composite indicates the strength of a multiplicative term, and in the post-fit stage, the composite indicates the difference of the goodness-of-fit of two nested models. The glyphs are rendered in AR and this allows the glyphs to have more degrees-of-freedom. For instance, the glyphs can float above the tablet screen. The glyphs can also appear outside the screen. This allows for exploration of above-the-display and around-the-display paradigms. The AR glyphs rendering system may use libraries such as Unity™ v2020.3 with OpenXR, MRTK, or any other suitable libraries.

Due to hardware limitation of the implemented prototype, the implementation used 2D rectangle glyphs, but rectangular prisms, 2D circles, spheres or any other type of markers could be used, as would be apparent to a person skilled in the art. For implementation purpose, it may be preferable that lights from the light sources in AR do not affect the brightness of the glyphs and that objects in the AR cannot cast shadows onto the glyphs.

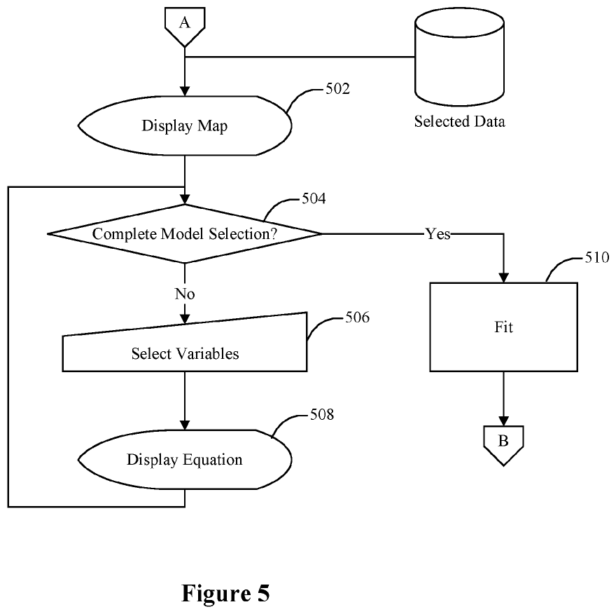

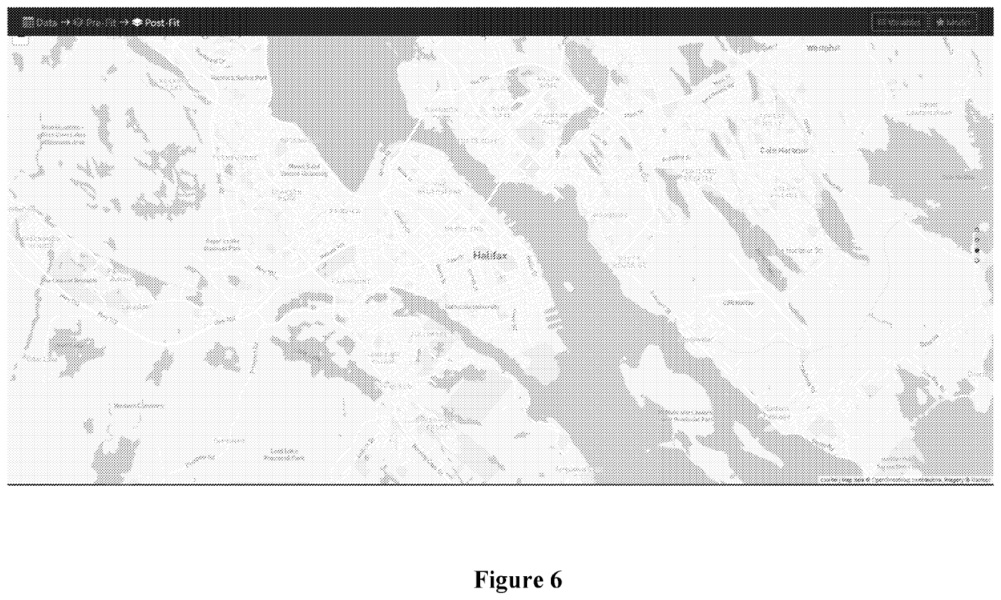

Turning to FIG. 5, a map is displayed to the user, step 502. The map is displayed on the tablet, which preferably sits on a fixed surface. FIG. 6 illustrates a corresponding HTML prototype of such a map. In the example of FIG. 6, an actual map is displayed, but a person skilled in the art would understand that the map could represent something else than a terrain, that it could represent any data that can be shown in two dimensions or three dimensions. If the dataset does not have geospatial data, a spatialization technique can be used to create a map to be displayed on the tablet. Spatialization is a technique of assigning locations based on other properties. Spatialization may be implemented using one of the spatialization method described in (André Skupin & Sara Irina Fabrikant (2003) Spatialization Methods: A Cartographic Research Agenda for Non-geographic Information Visualization, Cartography and Geographic Information Science, 30:2, 99-119).

The data is displayed in the AR device, over and around the map that is displayed on the tablet.

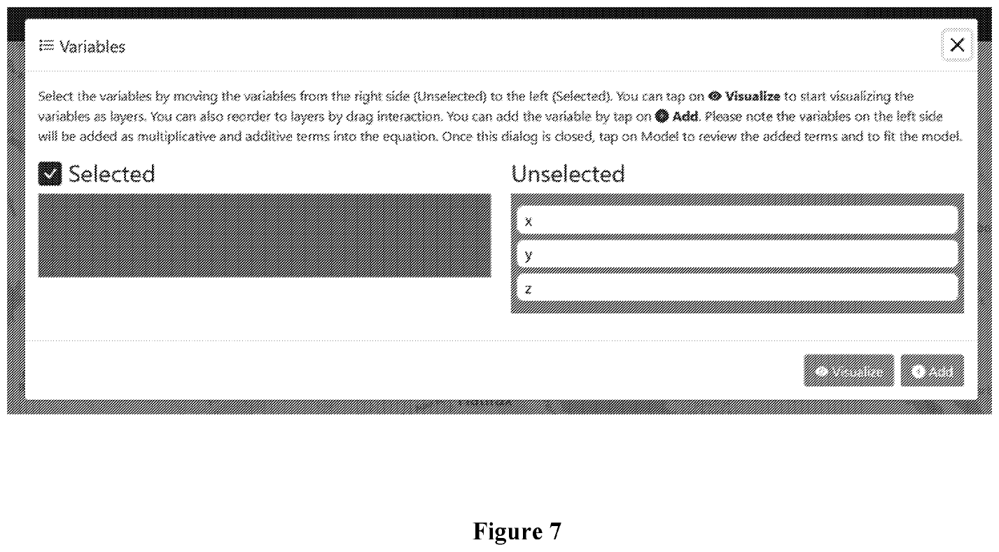

The next step 504 of the algorithm is to check if the model selection is completed. When the data is displayed for the first time, the answer to step 504 is no and the user can select some variables to be displayed in the AR device. FIG. 7 illustrates a prototype user interface presenting variable selection dialog that can be used for this purpose. This dialog opens, for example, when the user taps on a “variables” button. The user can use drag-and-drop to select variables to be visible on the screen, then tap on “visualize” to show the glyphs based on their selection.

When previous variables have been selected, and visualized, if the user is not satisfied with the selection, further variable selection is possible, step 506. FIGS. 11a and 11b, which will be explained in more details further below show two modes in which the data can be visualized. In FIG. 11a, the values for three variables are displayed on top of the tablet, one variable per layer. The shade of grey of the squares represent the value (normalized between 0 and 1) for the particular variable at a particular location of the map. FIG. 11b shows an alternative way to display the data, where the values of all three variables have been multiplied to have a single value at a particular location of the map. This may be useful to detect trends in relation with areas of the map (e.g., the multiplication of the three variables has high values in certain areas). It should be noted that, in FIGS. 11a, b and c, two rectangles that overlap are not indicative of further information, the overlap is due to display artifacts because two datapoint are located too close to each other on the map.

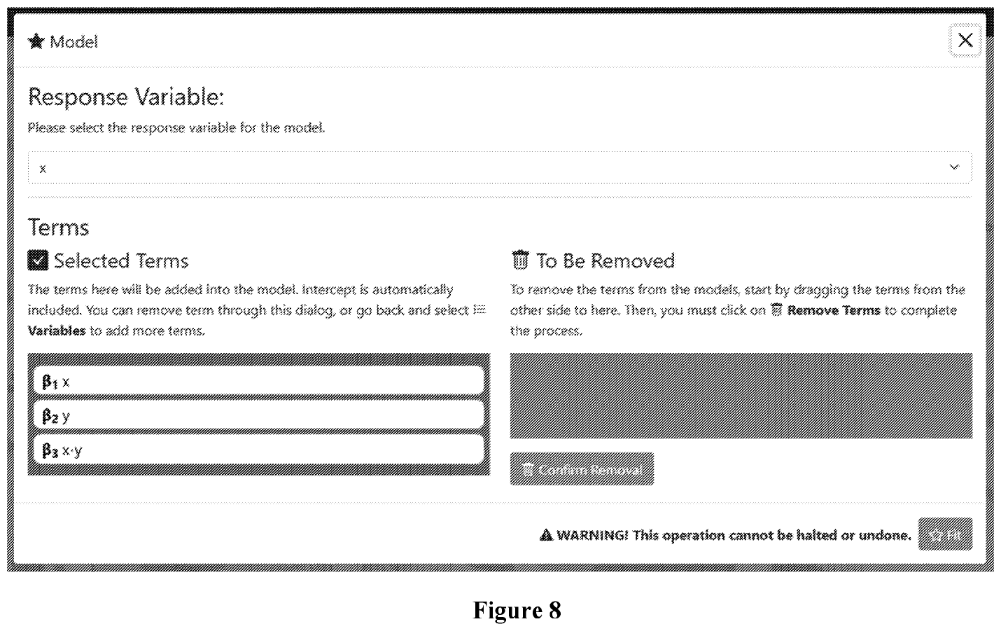

As part of the variable's selection process, equations for fitting the data are also displayed and can also be reviewed, step 508. This is the step in which the variables are added to an equation modeler. FIG. 8 illustrates a prototype user interface presenting an equation checking dialog for that purpose. The equation modeler is used to adjust the variables that will be in the equations. When the user adds the variables, the variables will also be added into the equation modeler as separate additive and multiplicative terms. The user can use drag-and-drop to add or eliminate terms.

Adjustments to the model can be made until the result is satisfying and the model is then fit to the data, step 510. The user taps on the “fit” button (FIG. 8) to create the model. Once the user added the variables into the model, all the additive and multiplicative terms are displayed.

FIG. 11c illustrates how glyphs are displayed after the fit has been made. FIG. 11c illustrates what is shown in the AR display, we do not see the tablet with the map in this image, but, in use, the user would see the glyphs of FIG. 11c over and around the map displayed on the tablet.

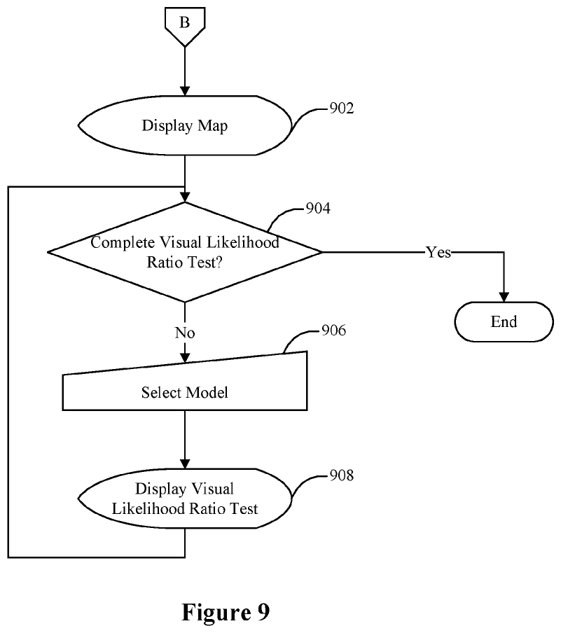

The next stage, the post-fit stage, is illustrated in FIGS. 9, 10 and 11c. Turning to FIG. 9, after the model is fitted into the data, step 510 of FIG. 5, the map is displayed again to the user, step 902. Two layers are displayed to the user (see FIG. 11c). The top layer represents the model with more variables (the full model) and the bottom layer represents the model whose variables are the subset of the full model (the restricted model). Alternatively, the top and bottom models can be models created from the fitting into two different equations while the user is iterating for finding the better fit into the dataset. Variance structures can be visualized and examined by the user, who has an opportunity to review the normalized log likelihood of both models. A likelihood is the probability of data being predicted by the model. The glyphs represent roughly where, in the map, the models may perform poorly. The color value of each glyph may be such that the top color indicates the likelihood of the observed number assuming the full model and the bottom color indicates the likelihood of the observed number assuming the restricted model. Alternatively, the top color may indicate the likelihood of a first model and the bottom color may indicate the likelihood of a second model.

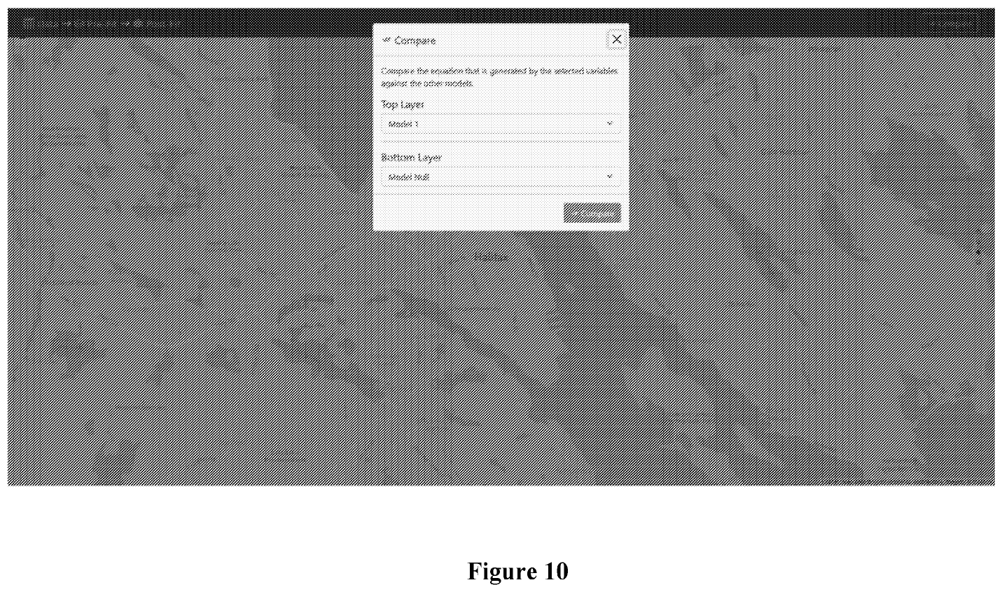

The system then checks if the visual likelihood ratio test is completed, step 904. If not, model selection is refined, step 906, and new or updated visual likelihood ratio test are presented to the user, step 908, who, by changing the variance structure, can also visualize effect sizes. Once the user is satisfied with the visual likelihood ratio test, the model selection process ends. FIG. 10 illustrates a corresponding HTML prototype of an interface allowing to select two models, sharing the same set of variables, for comparison (to test against each other), where one model uses less variables than the other. The model on the top is nested inside the model on the bottom. Alternatively, the interface can allow selecting two models previously generated.

The user may iterate with: the variable selection 506, the equation editing (FIG. 8) and glyphs display (post fit, FIG. 11c) until satisfied, at which point the user can trigger the creation of the final model and the method ends.

It should be noted that if the user wants to compare different models (instead of the full model vs the restricted model), the user needs to go through at least two iterations of variables selection and equation editing. The glyphs, as illustrated in FIG. 11c, are meant to illustrate the contrast between two models. In one embodiment, the user will always compare the latest model generated with a previous one, but implementation could differ, as would be apparent to a person skilled in the art.

In the post-fit stage, the glyphs display normalized likelihood instead of data values. From the outset, the glyph color could be assigned to be the likelihood of the datum as the likelihood is already a value between zero and one. However, this approach runs into a problem when trying to compare two layers. In a likelihood test, the values have to be divided. This means that a shader that implements divisive blending is needed. However, not many devices, including HoloLens™ v2, support divisive blending. Fortunately, a concept called the effect size E_{L} can be used. The effect size, when applied to a single data point, is essentially a subtraction between two log-likelihood that have been scaled between zero and one, and is computed using

$${E}_{L} = \frac{ln {p}_{i}}{ln min q} - \frac{ln {q}_{i}}{ln min q} .$$

In this case p represents the likelihood of the top model, and q represents the likelihood of the bottom model. For the top layer, the color value, c, can be assigned the term on the left, E_{L}. For the bottom layer, the term on the right can be used.

The subtractive blender is considerably simpler than the multiplicative one on HoloLens™ and there is no concern with interaction with the background. Since the background is transparent, the color values will be negative. However, the subtractive blend operation also includes the absolute operation at the end. This operation converts all negative values into positive ones.

FIG. 11a, b and c illustrate multiple examples of glyph appearance in the prototype system. The glyphs are displayed on the AR interface, over and around the tablet. FIGS. 11a and 11b correspond to the pre-stage and FIG. 11c corresponds to the post-stage. In FIG. 11a, three variables are displayed simultaneously (these variables are shown in different shades of grey, superposed vertically).

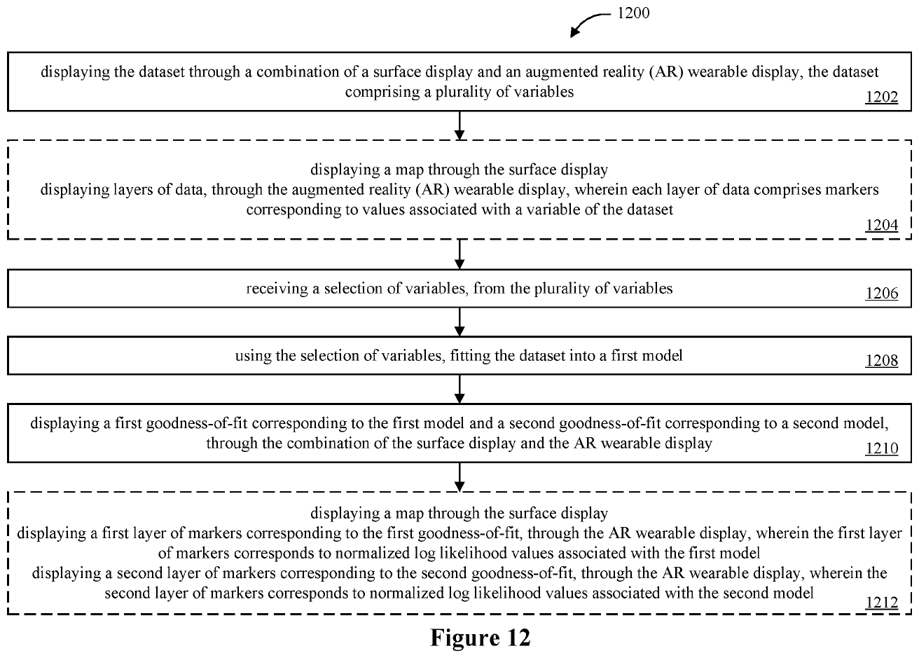

Turning to FIG. 12, there is provided a method 1200 for displaying and fitting a dataset into a model. The method comprises displaying, step 1202, the dataset through a combination of a surface display and an augmented reality (AR) wearable display, the dataset comprising a plurality of variables. The method comprises receiving, step 1206, a selection of variables, from the plurality of variables. The method comprises using, step 1208, the selection of variables, fitting the dataset into a first model. The method comprises displaying, step 1210, a first goodness-of-fit corresponding to the first model and a second goodness-of-fit corresponding to a second model, through the combination of the surface display and the AR wearable display. The second model may be based on the plurality of variables.

Displaying the dataset through the combination of the surface display and the augmented reality (AR) wearable display may further comprise, step 1204, displaying a map through the surface display and displaying layers of data, through the augmented reality (AR) wearable display, wherein each layer of data comprises markers corresponding to values associated with a variable of the dataset. The positions of the markers correspond to positions on the map.

Fitting the dataset into a first model, may comprise receiving a selection of terms for the model, and the model may be based on a mathematical expression.

The first and second models may be generalized linear models and the generalized linear models may be lineal regression models or logistic regression models.

Displaying the first goodness-of-fit corresponding to the first model and the second goodness-of-fit corresponding to the second model may comprise, step 1212, displaying a map through the surface display, displaying a first layer of markers corresponding to the first goodness-of-fit, through the AR wearable display, wherein the first layer of markers corresponds to normalized log likelihood values associated with the first model and displaying a second layer of markers corresponding to the second goodness-of-fit, through the AR wearable display, wherein the second layer of markers corresponds to normalized log likelihood values associated with the second model. The positions of the markers correspond to positions on the map.

The map may be a surface corresponding to geospatial information or to a spatialization of a portion of the dataset.

The markers may be rectangular, rectangular prism, circular or spherical markers and the values may be normalized and represented as color values or greyscale values.

The method may further comprise iterating between receiving the selection of variables, fitting the dataset into a first model using the selection of variables and displaying the first and second goodness-of-fit. The first and second models may correspond to models fitted during different iterations.

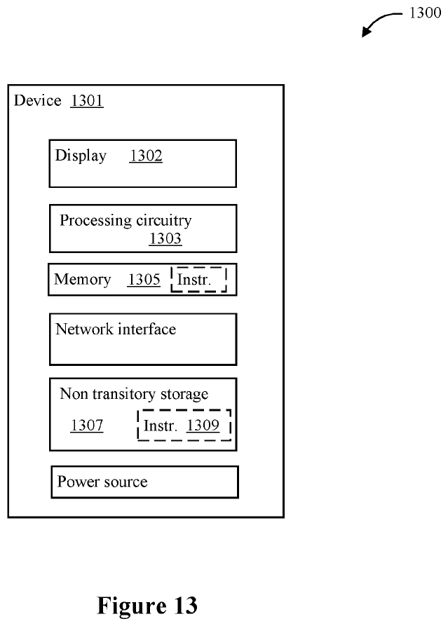

Referring to FIG. 13, there is provided a device 1301, in which functions and steps described herein can be implemented.

The device 1301 (which may go beyond what is illustrated in FIG. 13), may be a user device, such as a smartphone, tablet, any other surface display, an augmented reality (AR) wearable display, computer, wearable, connected vehicle, including but not limited to bicycle, car, truck, plane, drone, etc.

The device 1301 comprises a display 1302, which may be a surface display or a 3D display. The device 1301 comprises processing circuitry 1303 and memory 1305. The memory 1305 can contain instructions executable by the processing circuitry 1303 whereby functions and steps described herein may be executed to provide any of the relevant features and benefits disclosed herein.

The device 1301 may also include non-transitory, persistent, machine-readable storage media 1307 having stored therein software and/or instruction 1309 executable by the processing circuitry 1303 to execute functions and steps described herein. The device may also include network interface(s) and a power source.

The instructions 1309 may include a computer program for configuring the processing circuitry 1303. The computer program may be stored in a physical memory local to the device, which can be removable, or it could alternatively, or in part, be stored in the cloud. The computer program may also be embodied in a carrier such as an electronic signal, optical signal, radio signal, or computer readable storage medium.

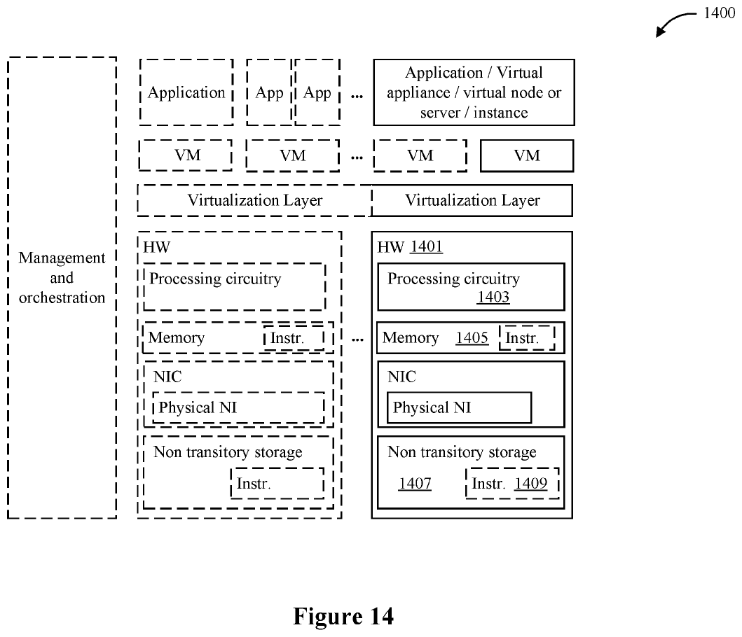

Referring to FIG. 14, there is provided a virtualization environment 1400 in which functions and steps described herein can be implemented.

The virtualization environment 1400 (which may go beyond what is illustrated in FIG. 14), may comprise systems, networks, servers, nodes, devices, etc., that are in communication with each other either through wire or wirelessly, e.g., through a network interface component (NIC) comprising physical network interface(s). Some of the functions and steps described herein may be implemented as one or more virtual components (e.g., via one or more applications, components, functions, virtual machines, containers, etc.) executing on one or more physical apparatus in one or more networks, systems, environment, etc.

A virtualization environment provides hardware 1401 comprising processing circuitry 1403 and memory 1405. The memory 1405 can contain instructions executable by the processing circuitry 1403 whereby functions and steps described herein may be executed to provide any of the relevant features and benefits disclosed herein.

The hardware 1401 may also include non-transitory, persistent, machine- readable storage media 1407 having stored therein software and/or instruction 1409 executable by the processing circuitry 1403, or downloadable into another apparatus or device, to execute functions and steps described herein.

The instructions 1409 may include a computer program for configuring the processing circuitry 1403. The computer program may be stored in a removable memory, such as a portable compact disc, portable digital video disc, or other removable media. The computer program may also be embodied in a carrier such as an electronic signal, optical signal, radio signal, or computer readable storage medium.

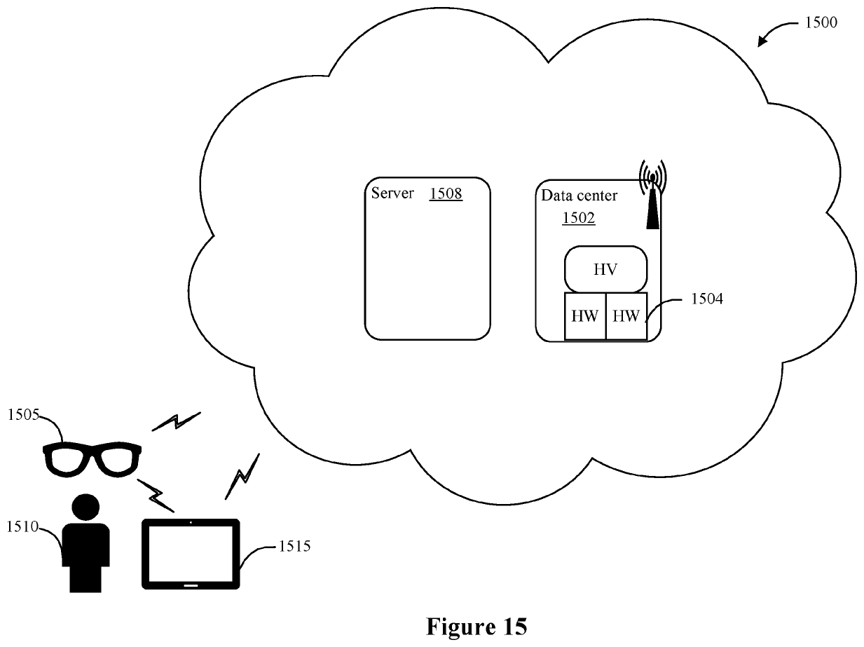

Referring to FIG. 15, there is provided a cloud system 1500 in which functions and steps described herein can be implemented.

The cloud system 1500 comprises one or a plurality of data centers, or server clusters, 1502, some data centers may have capacity to communicate wirelessly through antennas. A data center may include a hypervisor (HV) creating and running virtual machines on hardware (HW) 1504. The cloud system may also include standalone servers 1508 that have large computing power, large memory, etc.

The user 1510, who uses the system described herein, has access to an AR wearable display 1505 and a tablet or other surface display 1515. Some of the computations can be offloaded from the AR wearable display 1505 and/or from the tablet or other surface display to the cloud, i.e., to a server 1508 or a hardware 1504 in a data center 1502.

Referring to FIGS. 13 to 15, there is provided a system, comprising a surface display 1515, 1301 and an augmented reality (AR) wearable display 1505, 1301. The surface and AR wearable displays each comprise processing circuits 1303 and a memory 1305. The memory contains instructions executable by the processing circuits whereby the system is operative to display the dataset through the surface display and the augmented reality (AR) wearable display, the dataset comprising a plurality of variables. The system is operative to receive a selection of variables, from the plurality of variables. The system is operative to use the selection of variables for fitting the dataset into a first model. The system is operative to display a first goodness-of-fit corresponding to the first model and a second goodness-of-fit corresponding to a second model, through the combination of the surface display and the AR wearable display. The second model may be based on the plurality of variables.

The dataset may be displayed through the combination of the surface display and the AR wearable display by displaying a map through the surface display and displaying layers of data, through the AR wearable display, wherein each layer of data comprises markers corresponding to values associated with a variable of the dataset. The positions of the markers correspond to positions on the map.

The first goodness-of-fit corresponding to the first model and the second goodness-of-fit corresponding to the second model may be displayed by displaying a map through the surface display, displaying a first layer of markers corresponding to the first goodness-of-fit, through the AR wearable display, wherein the first layer of markers corresponds to normalized log likelihood values associated with the first model and displaying a second layer of markers corresponding to the second goodness-of-fit, through the AR wearable display, wherein the second layer of markers corresponds to normalized log likelihood values associated with the second model. The positions of the markers correspond to positions on the map.

The map may be a surface corresponding to geospatial information or to a spatialization of a portion of the dataset. The markers may be rectangular, rectangular prism, circular or spherical markers and the values may be normalized and represented as color values or greyscale values.

There is provided a non-transitory computer readable media 1307, 1407 having stored thereon instructions 1309, 1409 for displaying and fitting a dataset into a model. The instructions comprise displaying the dataset through a combination of a surface display and an augmented reality (AR) wearable display, the dataset comprising a plurality of variables. The instructions comprise receiving a selection of variables, from the plurality of variables. The instructions comprise using the selection of variables, fitting the dataset into a first model. The instructions comprise displaying a first goodness-of-fit corresponding to the first model and a second goodness-of-fit corresponding to a second model, through the combination of the surface display and the augmented reality (AR) wearable display. The non-transitory computer readable media 1307, 1407 may further store any instructions described herein.

There is also provided a surface display 1515 operative to display a map and operative to function in collaboration with an AR wearable display. The surface display is operative to execute any of the steps related to the surface display described herein.

There is also provided an AR wearable display 1505 operative to display layers of data in the form of markers and operative to function in collaboration with a surface display. The AR wearable display is operative to execute any of the steps related to the AR wearable display described herein.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A method for displaying and fitting a dataset into a model, comprising:
displaying the dataset through a combination of a surface display and an augmented reality (AR) wearable display, the dataset comprising a plurality of variables;
receiving a selection of variables, from the plurality of variables;
using the selection of variables, fitting the dataset into a first model; and
displaying a first goodness-of-fit corresponding to the first model and a second goodness-of-fit corresponding to a second model, through the combination of the surface display and the AR wearable display.

2. The method of claim 1, wherein the second model is based on the plurality of variables.

3. The method of claim 1, wherein displaying the dataset through the combination of the surface display and the augmented reality (AR) wearable display comprises:
displaying a map through the surface display; and
displaying layers of data, through the augmented reality (AR) wearable display, wherein each layer of data comprises markers corresponding to values associated with a variable of the dataset;
wherein positions of the markers correspond to positions on the map.

4. The method of claim 1, wherein fitting the dataset into a first model, comprises receiving a selection of terms for the model, and wherein the model is based on a mathematical expression.

5. The method of claim 1, wherein the first and second models are generalized linear models.

6. The method of claim 5, wherein the generalized linear models are lineal regression models or logistic regression models.

7. The method of claim 1, wherein displaying the first goodness-of-fit corresponding to the first model and the second goodness-of-fit corresponding to the second model comprises:
displaying a map through the surface display;
displaying a first layer of markers corresponding to the first goodness-of-fit, through the AR wearable display, wherein the first layer of markers corresponds to normalized likelihood values associated with the first model; and
displaying a second layer of markers corresponding to the second goodness-of-fit, through the AR wearable display, wherein the second layer of markers corresponds to normalized likelihood values associated with the second model;
wherein positions of the markers correspond to positions on the map.

8. The method of claim 3, wherein the map is a surface corresponding to geospatial information or to a spatialization of a portion of the dataset.

9. The method of claim 3, wherein the markers are rectangular, rectangular prism, circular or spherical markers and wherein the values are normalized and represented as color values or greyscale values.

10. The method of claim 1, further comprising iterating between receiving the selection of variables, fitting the dataset into a first model using the selection of variables and displaying the first and second goodness-of-fit.

11. The method of claim 10, wherein the first and second models correspond to models fitted during different iterations.

12. A system, comprising a surface display and an augmented reality (AR) wearable display, the surface and AR wearable displays each comprising processing circuits and a memory, the memory containing instructions executable by the processing circuits whereby the system is operative to:
display the dataset through the surface display and the augmented reality (AR) wearable display, the dataset comprising a plurality of variables;
receive a selection of variables, from the plurality of variables;
use the selection of variables for fitting the dataset into a first model; and
display a first goodness-of-fit corresponding to the first model and a second goodness-of-fit corresponding to a second model, through the combination of the surface display and the AR wearable display.

13. The system of claim 12, wherein the second model is based on the plurality of variables.

14. The system of claim 12, wherein the dataset is displayed through the combination of the surface display and the AR wearable display by:
displaying a map through the surface display; and
displaying layers of data, through the AR wearable display, wherein each layer of data comprises markers corresponding to values associated with a variable of the dataset;
wherein positions of the markers correspond to positions on the map.

15. The system of claim 12, wherein the first goodness-of-fit corresponding to the first model and the second goodness-of-fit corresponding to the second model are displayed by:
displaying a map through the surface display;
displaying a first layer of markers corresponding to the first goodness-of-fit, through the AR wearable display, wherein the first layer of markers corresponds to normalized likelihood values associated with the first model; and
displaying a second layer of markers corresponding to the second goodness-of-fit, through the AR wearable display, wherein the second layer of markers corresponds to normalized likelihood values associated with the second model;
wherein positions of the markers correspond to positions on the map.

16. The system of claim 14, wherein the map is a surface corresponding to geospatial information or to a spatialization of a portion of the dataset.

17. The system of claim 14, wherein the markers are rectangular, rectangular prism, circular or spherical markers and wherein the values are normalized and represented as color values or greyscale values.

18. A non-transitory computer readable media having stored thereon instructions for displaying and fitting a dataset into a model, the instructions comprising:
displaying the dataset through a combination of a surface display and an augmented reality (AR) wearable display, the dataset comprising a plurality of variables;
receiving a selection of variables, from the plurality of variables;
using the selection of variables, fitting the dataset into a first model; and
displaying a first goodness-of-fit corresponding to the first model and a second goodness-of-fit corresponding to a second model, through the combination of the surface display and the augmented reality (AR) wearable display.

19. (canceled)
